(19) United States
(12) Patent Application Publication
(10) Pub. No.: US 2017/0121632 A1
(43) Pub. Date: May 4, 2017

(54) SYSTEMS AND METHODS FOR VARNISH ABATEMENT AND REMOVAL FROM IN-SERVICE FLUIDS AND COMPONENTS

(71) Applicant: FLUITEC INTERNATIONAL, LLC, Rutledge, GA (US)

(72) Inventors: Cristian A. Soto, Jersey City, NJ (US); Greg Livingstone, Tucson, AZ (US); Jatin N. Mehta, Jersey City, NJ (US); David L. Wooton, Beaverdam, VA (US)

(73) Assignee: FLUITEC INTERNATIONAL, LLC, Rutledge, GA (US)

(21) Appl. No.: 15/317,246

(22) PCT Filed: Jun. 11, 2015
(86) PCT No.: PCT/US15/35383

§ 371 Date: Dec. 8, 2016

Related U.S. Application Data
(60) Provisional application No. 62/010,657, filed on Jun. 11, 2014.

(51) Int. Cl. C10M 175/00; B01D 17/02

(52) U.S. Cl. CPC C10M 175/0008; C10M 175/0016; C10M 175/0058; B01D 17/0202

(57) ABSTRACT

Systems and methods for varnish abatement and removal from in-service fluids and components of an industrial lubricated system. The systems and methods may include adding an effective amount of a solubility enhancer to the in-service fluid, and contacting the mixture with a medium having acrylamide or styrenic functionality to remove contaminants from the mixture. Systems may include a medium circuit having a medium pump and a medium component and a solubility enhancer reservoir arranged to dispense solubility enhancer to the reservoir. Methods may include pre-conditioning the in-service fluid before adding solubility enhancer.

### FIELD OF THE INVENTION

In various example aspects, the invention relates to systems and methods for varnish abatement and removal from in-service lubricant in industrial lubricated systems e.g. turbines, compressors, injection moulding hydraulic systems. In certain aspects, the invention relates to removing degradation products (e.g., oxidation by-products) from in-service lubricating and hydraulic fluids and removing contaminant films from machine components. In yet further aspects, the invention relates to the addition of additives to the in-service lubricating and hydraulic fluids to restore various lubricant properties such as oxidation resistance and antifoaming characteristics.

### BACKGROUND OF THE INVENTION

A lubricant for a machine (e.g., motor oil) degrades over time. As the formation of degradation products (e.g., oxidation by-products) from the lubricants and machine components increases over time, due to, for example, machine usage and heat, the incidence of the formation of harmful varnish on critical machine components (e.g., bearings, seals, valves, and governor systems) increases.

Lubricating oils undergo thermal and mechanical stresses that cause their additives and basestock to degrade. This chemical process changes the original molecules that make up the lubricant into less stable and less soluble degradation by-products. These degradation by-products can exist in either a dissolved or suspended form depending upon the chemistry and temperature of the lubricant. When the by-products are in a suspended state, they are at risk of settling out of the lubricant and forming deposits in sensitive areas of critical lubrication or hydraulic systems. These deposits are also commonly referred to as sludge and varnish.

The varnish causing suspended materials can be removed to various extents via, for example, electrostatic separators, chemical and mechanical flushes or particle filters. The solubilized varnish causing materials can be removed by adsorption media such as ion exchange resins.

U.S. Patent Application Publication No. 2009/0001023 describes removing soluble degradation by-products in lubricating oils using a polystyrene resin. It was found however that the polystyrene resin could easily oxidize when stored at room temperature. In addition to creating a toxic amine gas, the oxidized resins created several performance and aesthetic problems.

U.S. Pat. No. 5,661,117, U.S. Pat. No. 6,358,895 and U.S. Patent Application Publication No. 2005/0077224 all discuss using an ion exchange resin process to remove degraded phosphate ester acids to prolong the life of phosphate ester fluids. It was found however that the polystyrene resin could easily oxidize when stored at room temperature. When oxidized resins were used to treat phosphate ester fluids, they had a negative impact on the fluid's resistivity. When the resistivity of the fluid drops below 5 GOhm-cm, the fluid is at risk of electrokinetic wear causing servo-valve malfunction.

U.S. Patent Application Publication No. 2011/0089114 discusses a process for absorbing and adsorbing oil degradation products from lubricating oils.

There exists a need in the art for a process for removing degradation by-products that does not have the limitations of the prior art.

### BRIEF SUMMARY OF THE INVENTION

In various example aspects, the invention is directed to methods of removing compounds from an in-service fluid and components in a lubricating system, comprising adding an amount of a solubility enhancer to the in-service fluid to form a mixture; and contacting the mixture with a medium having acrylamide or styrenic functionality to remove the compounds.

In other example aspects, the invention is directed to systems for removing compounds from an in-service fluid and components in a lubricating system, comprising: a medium circuit comprising a medium pump and a medium component, wherein the medium circuit recirculates the in-service fluid through a reservoir of the lubricating system; and a solubility enhancer reservoir arranged to dispense solubility enhancer to the reservoir.

### BRIEF DESCRIPTION OF THE DRAWINGS

The various aspects of the invention will be more readily understood from the detailed description presented below and in conjunction with the attached drawings, of which:

FIG. 1 shows a system for varnish abatement and removal from an industrial lubricated system according to various example aspects of the invention.

FIG. 2 shows a system for varnish abatement and removal from an industrial lubricated system according to various example aspects of the invention.

FIG. 3 shows results from an experiment using oils and mediums in accordance with various example aspects of the invention.

FIG. 4 shows results from an experiment evaluating in-service oil and in-service oil mixed with a solubility enhancer having antioxidants in accordance with various example aspects of the invention.

FIG. 5 shows results from an experiment evaluating in-service oil, in-service oil with a solubility enhancer and in-service oil with a solubility enhancer together with an adsorption medium according to various example aspects of the invention.

FIG. 6 shows results from an experiment evaluating the effect of adding a solubility enhancer with an antioxidant and defoamer on the conditions of the in-service fluid according to various example aspects of the invention.

FIG. 7 shows performance of a varnish abatement and removal system and method according to various example aspects of the invention.

FIG. 8 shows performance of a varnish abatement and removal system and method according to various example aspects of the invention.

### DETAILED DESCRIPTION

According to various example aspects, the invention is directed to systems and methods for varnish abatement and removal from in-service fluids and components in industrial lubricated systems. In the following description, numerous details are set forth. It will be apparent, however, to one skilled in the art, that the present disclosure may be practiced without some or all of these specific details.

The systems and methods of the present invention provide numerous benefits as will become more apparent from the following description. Non-limiting examples of benefits include 1) cleaning working fluids and system components without having to stop or shut down operations; 2) reduction of maintenance and cost of particle filters; 3) removal of polar molecules than can further catalyze oxidation of the working fluid and removal of oxidative species that consume antioxidants thereby shortening the remaining useful life of the fluid; 4) reduction of the maintenance of a working fluid; and 5) significantly extending the life of a working lubricant e.g. by a factor>2×. Additional benefits and uses of the systems and methods of the invention will become apparent to those of ordinary skill in the art.

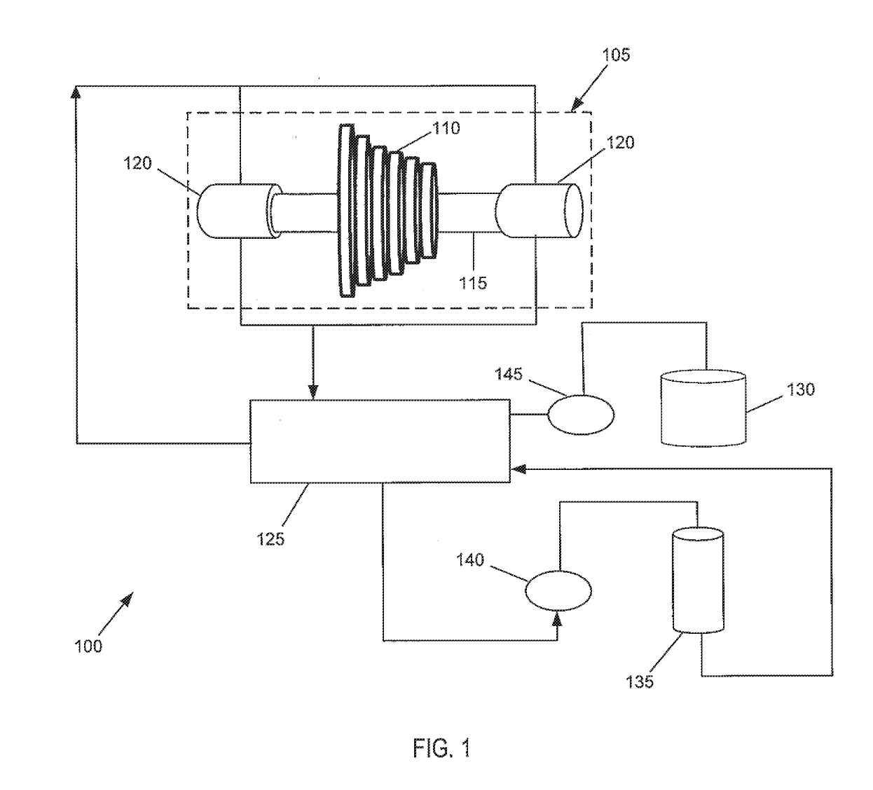

FIG. 1 shows an example system 100 for varnish abatement and removal from in-service fluids and components in an industrial lubricated system in accordance with various aspects of the invention. Although system 100 includes an engine 105, the systems and methods of the invention are useful for any rotating equipment where lubricants are used e.g. turbine oils, hydraulic oils, and gear oils. As shown in FIG. 1, the system 100 may include an engine 105 having a turbine 110 associated with a shaft 115, which is arranged between a pair of bearings 120. Lubricant may be supplied to the turbine 105 by a lubricant reservoir 125 containing, for example, a group I, II, III, IV or V oil. In accordance with various example aspects of the invention, the lubricant in the system 100 may be an in-service (i.e., working) fluid, that is, a fluid that has been in operation for a period of time (e.g., for about 6 months to about 10 years). The lubricant in the system 100 can be circulated through a medium 135 (e.g., one or more of a selective adsorption medium, an absorption medium and a filter) by a pump 140. In certain example aspects, the medium 135 may be a selective adsorption medium, such as an ion exchange column, and the pump 140 and medium 135 may be connected to the lubricant reservoir 125 via a kidney loop. In other example aspects, the medium may comprise one or more of a resin, a fibrous filter and a gel.

As further shown in FIG. 1, a solubility enhancer 130 may be supplied by a pump 145 from a drum or a tote (for example) to the lubricant reservoir 125 to form a solution with the lubricant in the system 100. The concentration of the solubility enhancer 130 in solution with the lubricant in the system 100 may be, for example, about 2% to about 20% by volume of the solution. Pump 140 and pump 145 may be any suitable pump for handling the lubricant, solubility enhancer and/or mixtures thereof. For example, pump 140 or pump 145 may be a positive displacement pump or a vacuum pump. Pump 140 or pump 145 may be a diaphragm pump, a centrifugal pump, a reciprocating pump, a rotary pump, a gear pump, a screw pump, a progressing cavity pump, a roots-type pump, a peristaltic pump, a hand pump or an oil pump. In certain aspects of the invention, pump 140 is a constant volume pump, such as a gear pump, and pump 145 is a hand pump or an oil pump.

In accordance with various example aspects of methods of the invention, during operation, in-service lubricant may be passed through the medium 135 for a period of time (e.g., about 30 minutes to about 4 hours, more particularly, for about 2 hours) during a pre-conditioning. The in-service lubricant can be drawn from the lubricant reservoir 125 by pump 140 and continuously passed through the medium 135 where the fluid exits the medium 135 and flows back to the lubricant reservoir 125. The flow rate of the fluid through the medium 135 is selected so as not to exceed the crushing pressure of the medium 135. The crushing pressure of an ion exchange medium may be, for example, about 50 psi to about 200 psi. Operating system pressures for the medium 135 may be about 20 psi to about 80 psi depending on the medium. For example, if the crushing pressure of the medium is 60 psi, then the operating pressure may be about 20 psi. According to certain aspects of the invention, the flow rate through the medium 135 may be about 0.5 gallon per minute to about 10 gallons per minute. The flow rate through the medium 135 may depend on the amount and type of contaminants in the in-service fluid, the medium selected, and the volume of the fluid in the lubricant tank 125. During pre-conditioning, as the lubricant in the system 100 passes through the medium 135, contaminants such as agglomerates and other impurities are removed (e.g., adsorbed, absorbed, filtered) from the in-service lubricant. In certain example aspects of the invention, the pre-conditioning may take about 1 to about 2 weeks to fully turn the system over. During this time, the medium 135 may remove active species that may otherwise consume additives in the solubility enhancer, such as antioxidants, and may partially reduce the Membrane Patch Colorimetry (“MPC”) value of the fluid in the system 100 as will be discussed in more detail below.

After pre-conditioning, the solubility enhancer 130 may be added to the lubricant reservoir 145. While the solubility enhancer 130 is added, fluid in the system 100 continues to flow through the medium 135 so that the medium 135 can continue to remove contaminants because there is continuous generation of oxidation compounds due to stressing of the lubricant in the system 100. According to example aspects of the invention, the solubility enhancer 130 can be added at a pre-determined flow rate, for example, about 1 gallon per minute to about 10 gallons per minute (depending on the volume of lubricant in the reservoir 125 and the amount of contaminants in the oil) in order to achieve good dispersion of the solubility enhancer within the lubricant. The solubility enhancer 130 may be added in an amount of about 5% to about 20% by volume of the solution. For example, a system having about 6000 gallons can be charged with the solubility enhancer at a flow rate of about 10 gpm. Larger or smaller systems can be charged at proportionally higher or lower flow rates.

It should be noted that engine 105 may continue to operate during the pre-conditioning and while the solubility enhancer is added to the system. Engine 105 may operate at a flow rate of about 1500 gallons per minute to about 1800 gallons per minute so that lubricant returning from the engine 105 to the lubricant reservoir 125 generates turbulence which provides good mixing of the added solubility enhancer 130 with the in-service lubricant. A mechanical mixer (not shown) may also be used in the lubricant tank 125 to mix the solubility enhancer 130 with the in-service lubricant.

Following the addition of the solubility enhancer 130 to the pre-conditioned lubricant, the resulting solution is circulated through the system 100 for a period of time, for example, the lifetime of the solution (e.g., about 10 to about 50 years), that is, or until the system 100 is taken offline or must be flushed and replaced with new lubricant. The medium 135 may last for about 4 to about 12 months, more particularly, about six (6) months, depending on the oxidation byproduct generation of the system 100. The oxidation byproduct generation may differ between systems. To establish when the medium 135 (e.g., ion exchange materials, filters, etc.) needs to be the changed, a quarterly MPC measurement can be performed. When two (2) consecutive MPC increases are recorded, the medium 135 may be changed.

According to further example aspects of the methods of the invention, as the solution of solubility enhancer 130 and pre-conditioned lubricant circulates through the system, it dissolves agglomerates and/or other particulates that have formed in the working fluid of the system 100. Additionally, when the mixture comes into contact with the turbine or compressor 105 and system components (e.g., filters, valves, governor systems, bearings, pipes, gears, seals, etc.), it dissolves deposits (e.g., vanish) thereon. More particularly, the addition of the solubility enhancer helps solubilize polar compounds that are formed due to oxidation of the working fluid and its additives. This allows for 1) polar compounds to remain in solution rather than to agglomerate, 2) solubilization of already suspended macromolecules and submicron particles made of agglomerated polar oxidation byproducts and 3) solubilization of already deposited material resulting in the cleaning of filters, valves, governor systems, bearings, pipes, gears, and seals among other components.

The solubility enhancer may include alkylated naphthalene, polyolesters, polyalphaolefin or alternatively polyalkylene glycol all of which may be soluble in mineral group I, II, III, IV and V oils. As varnish deposits in the system are solubilized, they release insoluble particles that are imbedded in the organic matrix that can be removed by particle filters. More particularly, not only material that is solubilized by the solvency enhancer is removed, but also solid particles (soot, wear particles, other particulate) are removed from the system.

The solubility enhancer may be formulated with antioxidants in order to restore the antioxidant properties of the working fluid. This addition further extends the life of the working fluid by replenishing its antioxidant properties. The antioxidants may include, for example, phenol and/or amine antioxidant compounds compatible with the working fluid being treated. The addition of antioxidants also minimizes the potential for accelerated consumption of antioxidants in the working fluid which may occur due to solubilization of active oxidative species. The solubilized active oxidative species may consume the antioxidants of the fluid and therefore, the replenishment of antioxidants from the solubility enhancer extends the usable life of the working fluid. In addition, the solubility enhancer can also be formulated with other functional additives to extend the useful life of the in-service fluid. For example, defoamers can be added to improve the foaming characteristics of the in-service fluid.

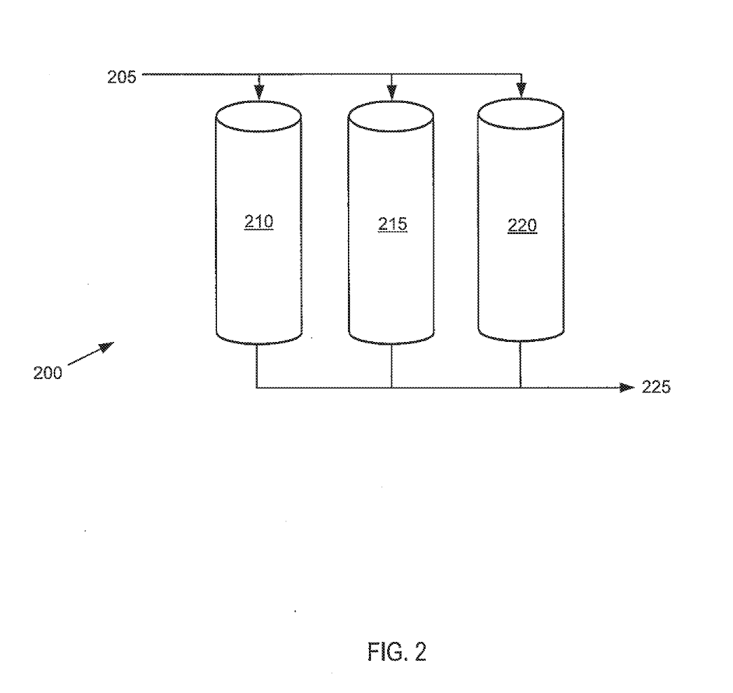

FIG. 2 shows an example media system for varnish abatement and removal from working fluids and components of industrial lubricated systems according to various aspects of the invention. As shown in FIG. 2, the medium 200 may be a combination of media 210, 215, 220 arranged in a parallel configuration or alternatively, the media 210, 215, 220 can be arranged in series (not shown). Fluid from a lubricant reservoir (not shown) 205 may be passed through the media 210, 215, 220 and returned to the lubricant reservoir 225. Each of the media 210, 215, 220 may be the same, for example, each may be an identical ion exchanger. Alternatively, one or more of the media 210, 215, 220 may differ from another, for example, media 210 may be an ion exchanger having one type of material while media 215 is an ion exchanger having a different type of material. Or media 215 may be a filter cartridge or other type of contaminant control device.

The selection of the medium 135 or media 210, 215, 220 may be customized based on the oxidation byproducts found in the in-service fluid. Selection of the medium may take into consideration the medium's contaminant removal performance (e.g., reduction of contaminants as measured by FT-IR and MPC), compatibility with the solubility enhancer (e.g., no reduction of media effectiveness due to the solubility enhancer), hydraulic performance (e.g., a low pressure drop across the media is preferred), and crushing pressure limitations (e.g., a high crushing pressure rating is preferred).

Additionally, passing the solubility enhanced fluid through the medium 135 or media 210, 215, 220 may be carried out in order to maintain the solubility capacity of the solvent and to remove the polar molecules and macromolecules from the system preventing the formation of deposits 1) when the working fluid in the system cools down and/or 2) the working fluid becomes saturated with degradation byproducts. The flow rates of the working fluid going through the medium 135 or media 210, 215, 220 may vary from about 0.5 gpm to about 10 gpm depending on, for example, the volume and type of medium or media being used and the viscosity of the fluid. In addition, different media can have different adsorption efficiencies as a function of flow rate, hence, the flow rate may be optimized for each medium 135 or media 210, 215, 220. The amount of material in the medium 135 or media 210, 215, 220 (e.g., ion exchange material) depends on the size of the total volume of working fluid being treated. For example, higher medium 135 or media 210, 215, 220 volumes can be accomplished by placing canisters containing the medium 135 or media 210, 215, 220, for example, in a parallel configuration (see FIG. 2). This configuration can help minimize pressure increases and maintain high flow. For example, the amount of material in the medium or media can be estimated as follows: 1) Calculate the amount of oxidation byproducts in, for example, a 6000 gallon lubricant reservoir having an MPC of 50; 2) Determine the amount of varnish by determining the actual weight of the M PC patches per volume of oil filtered and extrapolate to 6000 gallons; the resulting value may be about 1.5 Kg of varnish per 6000 gallons; 3) Conduct saturation experiments to determine the amount of varnish removed per gram of medium material used; this may result in the need of approximately 7 Kg of medium material needed to remove 1.5 Kg of varnish. This example assumes a static batch and therefore, a greater amount of medium material may be needed (e.g., 3×) to last for operations over a period of 6 months.

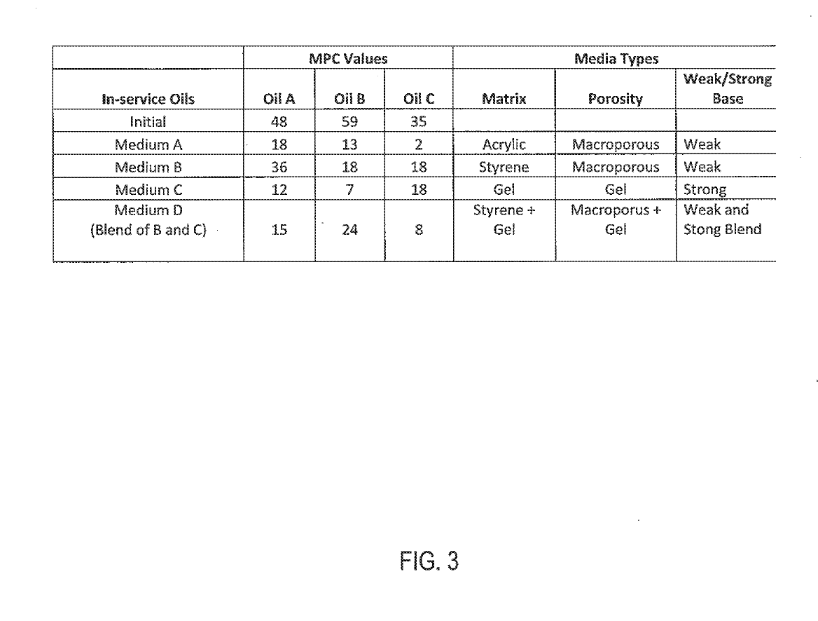

In various example aspects of methods according to the invention, the solubility enhancer can be used alone, that is, without a medium (or media). While addition of the solubility enhancer alone dissolves agglomerates and depositions in the working fluid, the use of the medium (or media) in the methods and systems can further extend the lifetime of the working fluid. According to various example aspects of the invention, the medium may be a selective adsorption medium, for example, an ion exchange medium that is styrenic or acrylic based, and weakly or strongly basic, and macroreticular or gel. FIG. 3 provides the results of tests conducted on three different types of oil, Oil A, Oil, B and Oil C using no medium (initial) or medium A, B, C or D. The results in FIG. 3 are based on “MPC” Values. Treatment level can be established by condition monitoring of the oil using Membrane Patch Colorimetry (MPC, ASTM D7843). The MPC method isolates oil degradation products on a membrane and measures the color with a surface spectrophotometer. The total amount of color generated by the deposits on the patch is reported, following the CIE LAB dE scale. The amount of isolated oil degradation products is higher in samples with higher dE values.

As shown in FIG. 3, the Initial MPC Values for each of Oil A, Oil B and Oil C were relatively high at 48, 59 and 35, respectively. Medium A, a weakly basic ion exchange material in a macroporous acrylic matrix, was effective in reducing the MPC Values for all of the Oils A, B and C. Mediums C and D, however, were even more effective than Medium A in reducing the MPC Value of Oil A. Similarly, Medium C was most effective in reducing the MPC Value of Oil B. While the disclosed media types provide good performance in improving the conditions of oils generally, it will become apparent to those of ordinary skill in the art whether other combinations and types of media can also be used for particular oils.

In addition to the MPC value, another measure of oil condition is the Remaining Useful Life Evaluation Routine (RULER, ASTM D6971). RULER is a system and a process that utilizes linear sweep voltammetry that can determine the remaining useful life of the fluid, based on the percentage of remaining antioxidant package from the initial levels in the fresh oil.

The MPC and RULER values may be evaluated together to determine the condition of a working fluid and how much solubility enhancer may be needed for a system. For example, higher treatments levels of about 7 vol % to about 20 vol % of solubility enhancer per volume of solution are designed for particularly degraded working fluids as established by MPC values larger than dE=40 and/or a reduction in antioxidant levels to below about 25% (as per the RULER peak area, amperage as function of voltage as is measured in Linear Sweep Voltametry) as measured by RULER. Intermediate levels of treatment from about 4 vol % to about 6 vol % of solvent enhancer per volume of solution may be used for fluids with M PC values of dE=20-40 and/or RULER values of about 25% to about 50% of initial signal of antioxidants. Low treatment levels of about 2 vol % to about 4 vol % of solubility enhancer per volume of solution may be used for fluids with MPC values of dE=0-20 and/or RULER values in excess of about 75% of initial RULER signal.

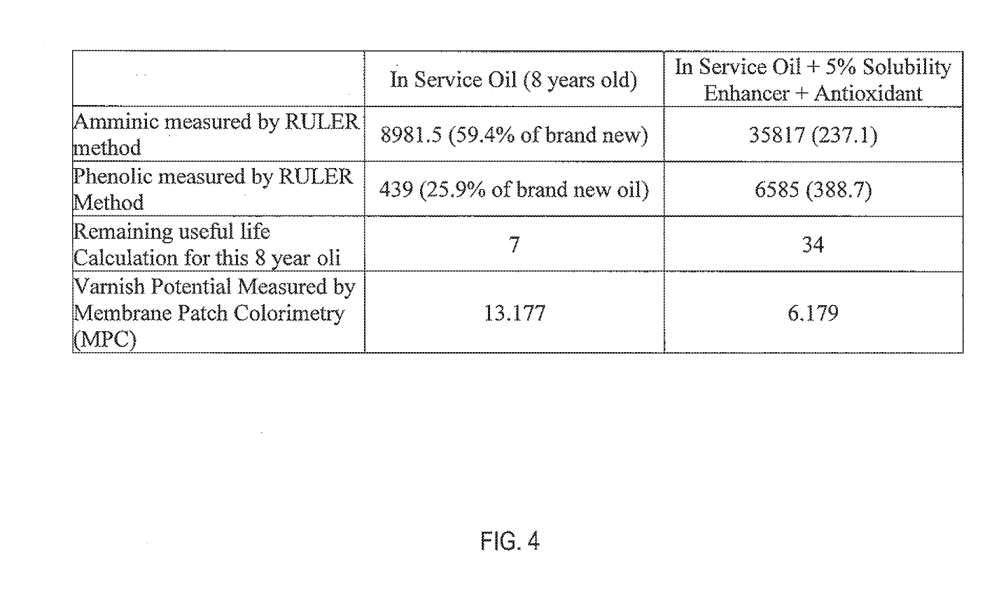

The useful remaining life of the working fluid can be extended by adding antioxidant additive packages to the solubility enhancer. FIG. 4 shows an example where solubility enhancer with antioxidants was added to an in service fluid. The data shows that the varnish potential was reduced as demonstrated by lowering the MPC dE value from about 13 to about 6 by the addition of solubility enhancer without the use of the adsorption media. In addition, the remaining useful life of the fluid was extended from about 7 to about 34 years (>2×).

FIG. 4 provides an example of how the solubility enhancer with an antioxidant package (amine and phenol antioxidant additives) can impact the remaining useful life of the in-service oil. Although the impact of each antioxidant type may be different, the solubility enhancer with antioxidant more than doubles the combined remaining useful life of the in-service oil. FIG. 4 shows that an oil that is 7 years old has lost approximately about 40% of the amminic antioxidant and about 74% of the phenolic antioxidant. The solubility enhancer with antioxidant increased the amine antioxidant by a factor of about 4 and the phenol antioxidant by a factor of about 15. Therefore, the remaining useful life increased from about 7 to about 34 years. Notably, treatment of an in-service fluid with a solubility enhancer containing antioxidants can improve the demulsibility of the in-service fluid, although this effect may not be present in all cases.

In certain example aspects of the invention, a lubricant reservoir containing about 6,000 gallons of oil with a viscosity of ISO 32 may be treated with about 5% by volume of solubility enhancer (containing antioxidants) per volume of solution. The formula of the solubility enhancer may be, for example, 75-85 vol % alkylated naphthalene, 6-9 vol % oil soluble in high molecular weight phenolic antioxidant and 9-13 vol % of diphenyl amine. The adsorption media may be three disposable canisters with axial flow in a parallel flow arrangement (see FIG. 2). The canisters could contain about 0.4 cubic feet of ion exchange material each. The flow rates may be anywhere from about 1 to about 10 gpm depending on the hydraulic resistance characteristics of the media. The flow rate may be regulated to ensure that the pressure across the media (e.g., the pressure drop) is well below the crushing pressure. For example, an operating condition across a media canister of 7 inches in diameter and 36 inches in height containing 0.4 cubic feet of ion exchange material and having a crushing pressure of 70 psi would operate at about 30 psi and 2 gpm.

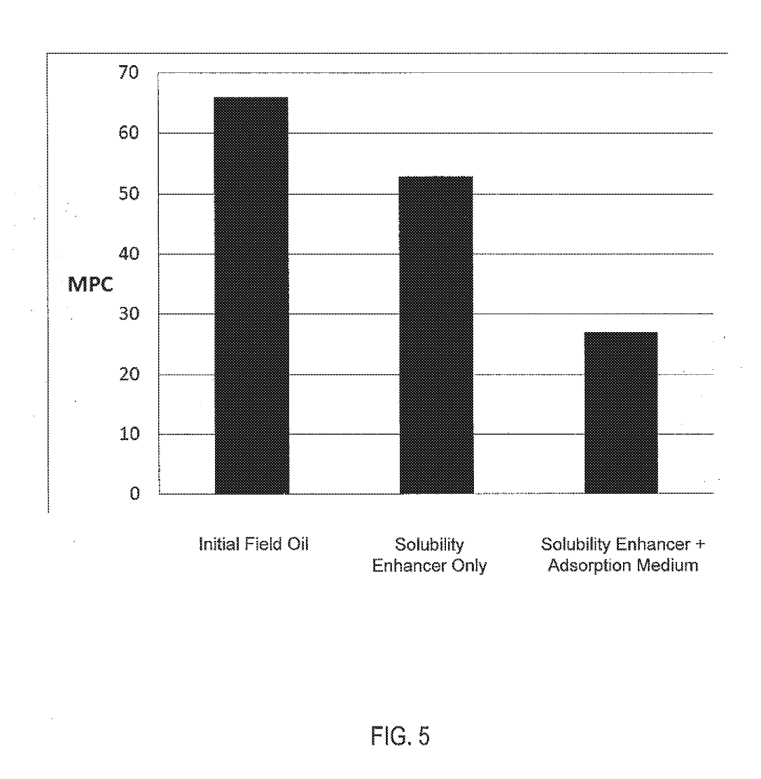

The synergy of using the solubility enhancer with the medium to remove varnish causing compounds from the oil is shown in FIG. 5. As shown, the MPC of the Initial Field Oil was about 65. The addition of the solubility enhancer reduced the MPC value to about 52. Incorporating an adsorption medium further reduced the M PC to about 27. FIG. 5 shows an example of reduction in varnish potential of an in service fluid after solubility enhancer treatment. The addition of the solubility enhancer reduces the varnish potential by solubilizing insoluble organic material in the oil. One way to describe the solvency of oil products is the Aniline point (measured in degrees Celsius). For example, a group II oil has an aniline point of 120° C.

The solubility enhancers useful in the systems and methods of the invention may have, for example, aniline points of about −20° C. to about 50° C. Solubility enhancement treatments of about 3% to about 20% by volume per volume of solution may reduce the aniline point of a working fluid proportionally to the concentration of the solubility enhancer in the solution and neat aniline point. Target reductions of aniline points can be about 4° C. to about 15° C. The solubility enhancer should also be soluble in the in service fluid at ambient conditions. In other words, a solubility enhancer with a low aniline point may be too polar to be blended with an in-service oil without causing separation of the additive (e.g., antioxidants) from the in-service oil. This separation may cause additive extraction from the base stock that may result in early oxidation of the in-service fluid causing the opposite of the desired effect i.e. it may cause varnish formation. Solubility enhancers having viscosities in the range of in-service fluids may be selected in order to maintain the viscosity of the working fluid e.g. ISC)(40) 32 viscosity (cSt).

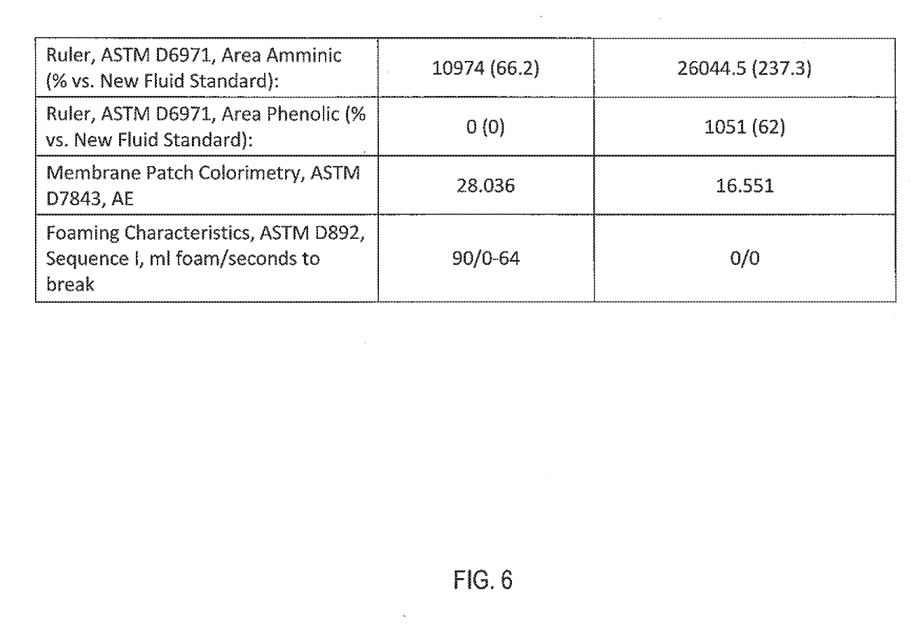

As discussed above, defoamers can be added to the solubility enhancer. FIG. 6 shows a table summarizing the impact of the addition of a solubility enhancer with antioxidant and defoamer. In this example an in-service oil without phenolic antioxidant is treated with an antioxidant package with both phenolic and amminic antioxidants. The formulation also includes a defoamer, this can be based on silicone-polyacrylate hybrid for use in non-aqueous fluids. The treatment reduced the varnish potential as measured by MPC, increased the antioxidant levels by a factor greater than about 4 in total antioxidant concentration, and finally the treatment reduced the foam from about 90 ml foam column to 0. The foam retention time was reduced from about 64 seconds to 0 seconds.

### Examples

Varnish deposits were extracted from a particulate filter. These were dried and weighed and added to 1) oil treated and 2) not treated with solvency enhancer to achieve the same concentration. The resulting fluids were then treated with equal amounts of adsorption media. The material adsorbed (adsorbate) onto the adsorption media were in turn extracted and their relative concentration established via FT-IR spectroscopy. It was found that the resin that was treated with the solvency enhanced oil sample contained 53% more polar adsorbates than the oil sample without solvency enhancer. This indicates that the solvency enhanced fluid was better able to dissolve polar compounds found in the varnish which, in turn, made it available for the media to remove it. This demonstrates the primary claim that the combination of a solvency enhancement coupled with an adsorbate media can result in the greater removal of varnish forming compounds from a system that contains agglomerated varnish particles or varnish deposits.

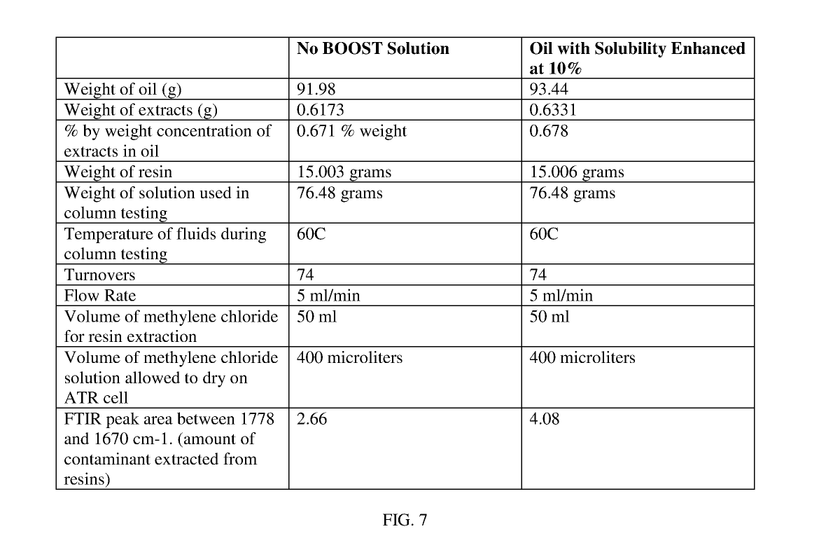

FIG. 7 shows the conditions and results of an experiment that tested an alkylated naphthalene solubility enhancer together with a styrenic weak base macroreticular resin. A varnish deposit extract was obtained from a particulate removal filter that was in operation for an undefined amount of time. It was established upon visual inspection that the filter had varnish deposits on its surface. The extract was obtained by 1) rinsing the filter with petroleum ether to remove oil and coarse particulates from the filter surface while keeping polar deposits on it, 2) the oxidation deposits were then solubilized using methylene chloride and dried into a solid form. This polar extract was weighed and added to a known volume of a) in-service oil and b) in-service oil with 10% solubility enhancer (alkylated naphthalene in this example).

The oils were heated for 48 hours at 60° C. to ensure a solubility steady state. The oil was then filtered with 10 and 5 micron filters to remove particulate matter that did not go into solution. The filtered oil was then circulated past a styrenic weak base macroreticular media. The medium was then extracted with a known methylene chloride volume. 400 microliter samples of the methylene chloride solutions were taken and allowed to air dry over a Fourier Transform Infrared Spectroscopy Attenuated Total Reflectance (FT-IR ATR) crystal. The intensity of the peak in the oxidation region of the spectra is dependent on the film thickness of the contaminants found in the methylene chloride solution. The results are summarized in the table in FIG. 6.

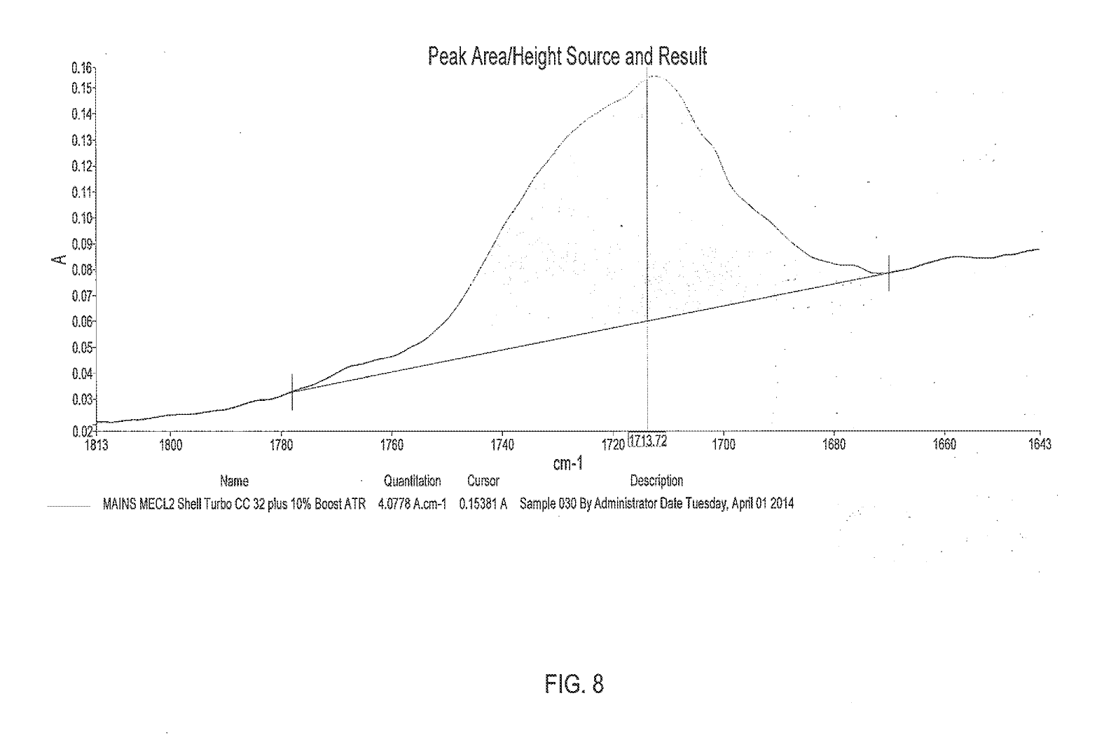

FIG. 8 shows a chart of graphical results of an example of FT-IR ATR Spectrum of the oxidation peak found in in the extract from the adsorption medium after it (the medium) treated oils with and without a solubility enhancer. A larger area under the peak is indicative of higher amount extracts adsorbed by the medium. Considering that everything is equal with the exemption of the 10% solubility enhancer added to the oil, it can be concluded that more extracts were solubilized by the solubility enhanced oil, thus allowing the medium to extract a larger quantity of extracts.

This shows how the combination of a solubility enhancer with an adsorption medium can help clean critical equipment surfaces. This synergy can be achieved with the removal of the oxidation byproducts from the cleaning fluid by the adsorption media, thereby retaining the cleaning power of the solubility enhancer. In this particular experiment, an improvement in the removal of contaminants from the “system” of 53% by volume was achieved when comparing the solubility enhanced treated oil vs. the non-treated oil.

The foregoing description, for purposes of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best utilize the disclosure and various examples with various modifications as may be suited to the particular use contemplated.

1. A method of removing compounds from an in-service fluid and components in a lubricating system, comprising:
adding an amount of a solubility enhancer to the in-service fluid to form a mixture; and
contacting the mixture with a medium having acrylamide or styrenic functionality to remove the compounds.

2. (canceled)

3. (canceled)

4. The method of claim 1, wherein the compounds comprise an oil degradation product comprising an oxidation by-product or a detergent contamination component.

5. The method of claim 1, wherein the medium comprises at least one material selected from a group consisting of a resin, a fibrous filter, a polymer and a gel.

6. (canceled)

7. The method of claim 1, wherein the solubility enhancer comprises at least one compound selected from a group consisting of alkylated naphthalene, polyolesters, polyalphaolefin and polyalkylene glycol.

8. The method of claim 1, wherein the amount of the solubility enhancer in the mixture comprises about 2% to about 20% by volume of the mixture.

9. (canceled)

10. The method of claim 1, wherein the solubility enhancer comprises an additive comprising at least one of an antioxidant and a defoamer.

11. The method of claim 10, wherein the antioxidant comprises at least one of an amine-based antioxidant and a phenol-based antioxidant.

12. The method of claim 1, further comprising pre-conditioning the in-service fluid with the medium before adding the solubility enhancer.

13. (canceled)

14. The method of claim 1, wherein the lubricating system remains on-line during the adding and the contacting.

15. The method of claim 1, wherein the method increases a useful lifetime of the in-service fluid by a factor of at least 2.

16. (canceled)

17. A system for removing compounds from an in-service fluid and components in a lubricating system, comprising:
a medium circuit comprising a medium pump and a medium component, wherein the medium circuit recirculates the in-service fluid through a reservoir of the lubricating system; and
a solubility enhancer reservoir arranged to dispense solubility enhancer to the reservoir.

18. (canceled)

19. (canceled)

20. The system of claim 17, wherein the compounds comprise an oil degradation product comprising an oxidation by-product or a detergent contamination component.

21. The system of claim 17, wherein the medium comprises at least one component selected from a group consisting of a selective adsorption medium, an absorption medium and a filter.

22. The system of claim 17, wherein the medium comprises at least one material selected from a group consisting of a resin, a fibrous filter, a polymer and a gel.

23. (canceled)

24. The system of claim 17, wherein the solubility enhancer comprises at least one compound selected from a group consisting of alkylated naphthalene, polyolesters, polyalphaolefin and polyalkylene glycol.

25. The system of claim 17, wherein the solubility enhancer reservoir is connected to a pump arranged to dispense the solubility enhancer into the in-service fluid to a concentration of about 2% to about 20% by volume of the solubility enhancer per volume of solution.

26. (canceled)

27. The system of claim, wherein the solubility enhancer comprises at least one additive comprising at least one of an antioxidant and a defoamer.

28. The system of claim 27, wherein the antioxidant comprises at least one of an amine-based antioxidant and a phenol-based antioxidant.

29. The system of claim 17, wherein the solubility enhancer increases a useful lifetime of the in-service fluid by a factor of at least 2.

30. The system of claim 17, wherein the in-service fluid comprises an oil.
